(19) United States
(12) Patent Application Publication
(10) Pub. No.: US 2025/0312997 A1
(43) Pub. Date: Oct. 9, 2025

(54) Composite film with clear texture and high quality and preparation process thereof

(71) Applicant: Guangdong Angsi Advanced Materials Technologies Co., Ltd., Shantou City (CN)

(72) Inventors: Xubin CHEN, Shantou City (CN); Yiming LIN, Shantou City (CN); Wenbing CAI, Shantou City (CN); Yangxin CHEN, Shantou City (CN); Guiyang CHEN, Shantou City (CN); Maosheng Ouyang, Shantou City (CN); Huiyun WANG, Shantou City (CN)

(73) Assignee: Guangdong Angsi Advanced Materials Technologies Co., Ltd., Shantou City (CN)

(21) Appl. No.: 19/094,927

(22) Filed: Mar. 30, 2025

(30) Foreign Application Priority Data
Apr. 9, 2024 (CN) 2024104187415

(51) Int. Cl. B32B 27/08; B32B 7/12; B32B 27/32; B32B 27/40; B32B 37/12; B32B 37/24; B32B 38/00; C09J 5/06

(52) U.S. Cl. CPC B32B 27/08; B32B 7/12; B32B 27/32; B32B 27/40; B32B 37/1207; B32B 37/24; B32B 38/145; C09J 5/06; B32B 2037/1215; B32B 2037/243; B32B 2255/10; B32B 2255/28; B32B 2274/00; B32B 2307/4023; B32B 2307/538; B32B 2307/54; B32B 2307/554; B32B 2307/5825; B32B 2307/7376; B32B 2307/748; B32B 2309/02; B32B 2323/10; B32B 2375/00; C09J 2400/286; C09J 2475/008

(57) ABSTRACT

The present invention discloses a composite film with clear texture and high quality and a preparation process thereof, relating to the technical field of composite films. The composite film with clear texture and high quality comprising a texture layer, a protective coating layer, a printed coating layer, an adhesive layer and a first substrate layer sequentially laminated from a top layer to a bottom layer, wherein the protective coating layer is provided on a surface of the texture layer facing the first substrate layer, the printed coating layer is provided on a surface of the protective coating layer facing the first substrate layer, and the texture layer is connected to the first substrate layer. The composite film with clear texture and high quality can realize multi-texture alignment printing by combining texture layers with printing, allowing one upper to have a variety of different textures and a variety of different colors.

### INCORPORATION BY REFERENCE

This application claims the benefit of priority from China Patent Application No. 2024104187415 filed on Apr. 9, 2024, the contents of which are hereby incorporated by reference in their entirety.

### TECHNICAL FIELD

The present invention relates to the technical field of composite films, and in particular to a composite film with clear texture and high quality, and also to a preparation process of the composite film with clear texture and high quality.

### BACKGROUND TECHNOLOGY

In existing footwear manufacturing, upper materials are not only required to focus on appearance designs, but also need to have excellent physical properties such as strength, flexibility and wear resistance to meet the requirements of uppers in daily use. Although traditional upper materials such as leather, fabric or synthetic materials perform well in some aspects, they still have problems with easy deformation, strength and flexibility. Traditional upper materials such as leather, fabrics or synthetics, while superior in some respects, still suffer from ease of deformation, strength and flexibility.

In order to solve strength problems, composite materials are therefore widely used in upper design to improve overall performance of uppers and to achieve a more aesthetic effect due to textured surfaces. However, in a traditional manufacturing process of shoe upper composite film, a decorative textures of material is usually realized by surface printing, a process which involves the printing of design patterns on surfaces of the composite film, while the printing of complex irregular textures needs to be done by hand, which on the one hand increases the complexity of production, and on the other hand, the handmade texture effect is not homogeneous and lacks a sense of delicacy. During the manufacturing process, a layer of protective oil is applied on top of printed patterns, which enhances the visual effect, but also covers the hand-made texture, resulting in a texture that is not significant enough to achieve the desired visual and tactile experience.

### SUMMARY OF THE INVENTION

In order to solve the technical problems, the present invention provides a composite film with clear texture and high quality, which has bright printing color, clear texture, and good quality and can be used for sole laying and peeled off at a printing part, and a preparation process thereof.

The technical solution of the present invention is as follows: a composite film with clear texture and high quality comprising a texture layer, a protective coating layer, a printed coating layer, an adhesive layer and a first substrate layer sequentially laminated from a top layer to a bottom layer, wherein the protective coating layer is provided on a surface of the texture layer facing the first substrate layer, the printed coating layer is provided on a surface of the protective coating layer facing the first substrate layer, and the texture layer is connected to the first substrate layer.

Further, a surface of the first substrate layer away from the texture layer is further provided with an anti-deformation support structure layer, the anti-deformation support layer comprises a hot melt adhesive layer and a second substrate layer, the hot melt adhesive layer is provided on a surface of the first substrate layer away from the texture layer, and the second substrate layer is connected to the first substrate layer by the hot melt adhesive layer.

Further, the texture layer is made of polypropylene texture papers, and the texture layer is provided with different textures in different areas and a plurality of colors are used in an alignment printing.

Further, a thickness of the texture layer is ≥0.1 mm.

Further, the protective coating layer is specifically a varnish layer.

Further, the second substrate layer is made of polypropylene texture papers.

Further, the thickness of the second substrate layer is ≥0.3 mm.

Further, the first substrate layer is made of a thermoplastic polyurethane elastomer material.

A preparation process of a composite film with clear texture and high quality for preparing the composite film with clear texture and high quality comprises:
S1, preparing a texture layer: setting different textures in different areas of the texture layer according to specific requirements, printing different colors in different areas of the texture layer by an alignment printing to obtain the texture layer;
S2, preparing a protective coating layer: adopting a corona process for coating and controlling a coating temperature at 90° C. and a thickness at 0.06 mm, coating a varnish material on a surface of the texture layer to form a protective coating layer, and transferring textures on the texture layer to the protective coating layer;
S3, preparing a printed coating layer: adopting an inner printing method and controlling the temperature at 40° C. to 60° C., forming a printing ink on one side with a protective layer on the texture layer, forming a printing coating, and obtaining a printing coating;
S4, preparing an adhesive layer: coating an adhesive to form the adhesive layer on one side of the texture layer on which a functional composite layer is formed; and
S5, preparing a composite film: the texture layer is joined and bonded to the first substrate layer through the adhesive layer, the first substrate layer has a temperature of 180° C. and a tension of 0.18 N, the curing temperature is controlled to 60° C., and curing time is set to 48 hours for baking to form the composite film.

Further, the preparation process further comprises: uniformly coating a hot melt adhesive on a surface of another side of the first substrate layer to form a hot melt adhesive layer, and connecting the first substrate layer and the second substrate layer through the hot melt adhesive layer.

The present invention has following beneficial technical effects:
1. Different textures are arranged in a plurality of areas of the texture layer and alignment printing is adopted to realize the multi-texture alignment printing.

Compared with the prior art of first cutting and then printing different colors and then manually splicing multiple textured papers with different patterns, the present invention, as an integrated printing, can achieve the effect of pre-processing with a better sense of design, and realizes the effect that different textures on the same shoe upper can have different colors, reducing steps of the entire shoe production process and improving production efficiency.
2. When the composite film is required to be properly pasted on a mesh, the composite film can be cut into a specified shape, the first substrate layer is adhered to the mesh by an adhesive, and then the texture layer is peeled off to form a product.
3. The printing coating is also coated and printed in a whole roll by an inner printing method, which is a purely mechanized operation and saves more time than a manual printing.
4. When the sole laying needs to be conducted, the first substrate layer is separated, and the adhesive layer is in contact with soles to achieve the adhesive effect, so that the sole laying of products can be directly conducted, which will make the sole adhesion better and save working hours.

### BRIEF DESCRIPTION OF THE DRAWINGS

FIG. 1 is a schematic diagram of a structure of a composite film with clear texture and high quality.

The reference signs in the drawings are indicated as follows:
1-texture layer; 2-protective coating layer; 3-printed coating layer; 4-adhesive layer; 5-first substrate layer; 6-hot melt adhesive layer; 7-second substrate layer.

### SPECIFIC EMBODIMENTS

In order to make technical means of the present invention more clearly understood and carry out the present invention according to the specification, specific embodiments of the present invention will be described in further detail below with reference to the accompanying drawings and embodiments, which are used to illustrate the present invention and is in no way intended to limit the scope of the present invention.

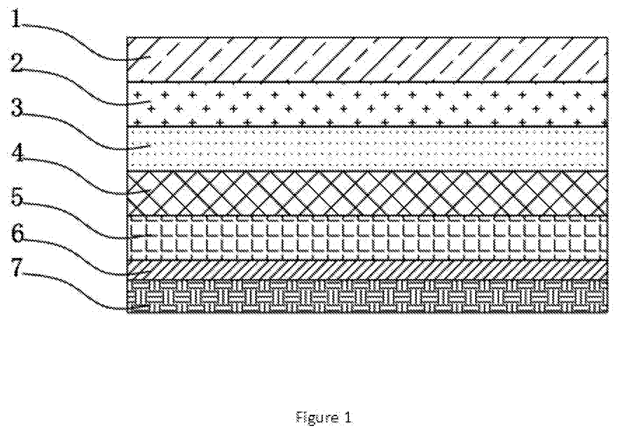

Referring to FIG. 1, the composite film with clear texture and high quality according to an embodiment of the present invention comprises a texture layer 1 made of polypropylene texture papers and having a thickness ≥0.1 mm, a protective coating layer 2 using a varnish coating layer, a printing coating layer 3, an adhesive layer 4 formed by coating on a side of the printing coating layer 3 facing a first substrate layer 5, and the first substrate layer 5 made of a thermoplastic polyurethane elastomer, which are sequentially laminated from a top layer to a bottom layer, wherein the protective coating layer 2 is provided on a side of the texture layer 1 facing the first substrate layer 5 in the form of varnish, and the protective coating layer 2 contains laser powder, phosphor, etc., the printed coating layer 3 is provided on a side of the protective coating layer 2 facing the first substrate layer 5 by printing ink by an inner printing method, and is coated and printed in a whole roll by the inner printing method, which is a purely mechanized operation and saves time than a manual printing.

In this embodiment, when the composite film is required to be properly pasted on a mesh, the composite film can be cut into a specified shape, the first substrate layer 5 is adhered to the mesh by an adhesive, and then the texture layer 1 is peeled off to form a product. When it is desired to attach the composite film to the sole, the first substrate layer 5 is separated and the composite film is directly attached to the sole by the adhesive layer 4.

Further, a surface of the first substrate layer 5 away from the texture layer 1 is further provided with an anti-deformation support layer, and the anti-deformation support layer comprises a hot melt adhesive layer 6 and a second substrate layer 7 made of polypropylene texture papers and having a thickness ≥0.3 mm, the hot melt adhesive layer 6 is provided on a surface of the first substrate layer 5 away from the texture layer 1, and the second substrate layer 7 is connected to the first substrate layer 5 through the hot melt adhesive layer 6. When the composite film is to be installed on the upper, the composite film is cut into the specified shape, and then the composite film is installed and adhered to the upper mesh by tearing off the second substrate layer 7 through the hot melt adhesive layer 6, and similarly the texture layer 1 needs to be separated to complete usage requirements and installation requirements.

In this embodiment, when the composite film is required to be properly pasted on a mesh, the composite film is cut into the specified shape, the second substrate layer 7 is peeled off, the composite film is bonded to the mesh through the hot melt adhesive layer 6, and then the texture layer 1 is peeled off to form a product. When it is desired to attach the composite film to the sole, the second substrate layer 7 is peeled off and the composite film is directly attached to the sole through the hot melt adhesive layer 6.

Further, the first substrate layer 5 and the second substrate layer 7 are at least one of PET, PP, PC, PVC, PE, OPP, TPU, PU, TPE, EVA, TPEE, PA, PPS, PI, ABS, PMMA, latex, rubber, silicone rubber, metal film, paper, artificial leather, artificial leather base fabric, animal skin, plant skin, fiber film, nonwoven fabric, and woven fabric.

In this embodiment, the first substrate layer 5 and the second substrate layer 7 are made of TPU materials. The TPU material itself has good wear resistance and good tensile properties, so the tear strength of TPU film is much better than that of ordinary rubber. TPU is one of the best choices for polymer materials and can maintain good bending resistance in different environments.

Further, the protective coating layer 2 is a varnish coating whose specific material is a resin such as polyether or polyurethane resin, and the varnish coating is capable of satisfying a peeling force test and has good flexure resistance and tortuosity resistance.

Further, the texture layer 1 is made of polypropylene texture papers, and the texture layer 1 is provided with different textures in different regions and has a plurality of colors for alignment printing, which can meet the requirements of a plurality of textures and complex patterns of different colors.

A preparation process of a composite film with clear texture and high quality for preparing the composite film with clear texture and high quality comprises following steps:
S1, preparing a texture layer 1: setting different textures in different areas of the texture layer 1 according to specific requirements, printing different colors in different areas of the texture layer 1 by an alignment printing to obtain the texture layer 1.

In this step, by directly setting different textures in different areas of the texture layer 1 and printing different colors in different areas by alignment printing, it is avoided that texture papers with different textures is cut to form a specified shape, and then different colors are printed and then different texture papers are manually imposed one by one to form the texture layer 1 in the prior art. This step adopts alignment printing and reduces manual operation by pre-processing, thus improving processing efficiency.

In the prior art, light transmittance at different positions is adjusted by slicing and then splicing and docking. In this step, ink colors are adjusted and printing is performed at different positions of the texture layer 1 by a multi-texture alignment printing, achieving different light transmittance effects at different positions after printing.
S2, preparing a protective coating layer 2: adopting a corona process for coating and controlling a coating temperature at 90° C. and a thickness at 0.06 mm, coating a varnish material on a surface of the texture layer 1 to form a protective coating layer 2, and transferring textures on the texture layer 1 to the protective coating layer 2.
S3, preparing a printed coating layer 3: adopting an inner printing method and controlling the temperature at 40° C. to 60° C., forming a printing ink on one side with a protective layer on the texture layer 1, forming a printing coating 3, and obtaining a printing coating 3.

In this step, the printed coating layer 3 is obtained by ink printing by an inner printing process to achieve the effect of wear resistance and anti-fouling, while a surface printing process is generally adopted in the prior art to avoid patterns are unclear and affected by rubbing and pollution in subsequent use of the composite film.

In addition, when the protective coating layer 2 is made of polyurethane resins, the material has excellent stain resistance, is easy to clean, is highly resistant to oil and grease, and is highly resistant to abrasion and UV color change, with a high degree of color stability.
S4, preparing an adhesive layer 4: coating an adhesive to form the adhesive layer 4 on one side of the texture layer 1 on which a functional composite layer is formed.
S5, preparing a composite film: the texture layer 1 is joined and bonded to the first substrate layer 5 through the adhesive layer 4, the first substrate layer 5 has a temperature of 180° C. and a tension of 0.18 N, the curing temperature is controlled to 60° C., and curing time is set to 48 hours for baking to form the composite film. Furthermore, the preparation process further comprises: uniformly coating a hot melt adhesive on a surface of the other side of the first substrate layer 5 to form a hot melt adhesive layer 6, and connecting the first substrate layer 5 and the second substrate layer 7 through the hot melt adhesive layer 6.

The composite film prepared by the above preparation process is tested, and test data are as follows:

| Serial | | | | Measured |
|---|---|---|---|---|
| No. | Test Items | Specification | | Values |
| 1 | Tensile in warp direction | 0.35 mm ≥ 6 | | 26.6 |
| | (kg/2.54 cm) | 0.5 mm ≥ 12 | | |
| | | 0.7 mm ≥ 18 | | |
| 2 | Tear strength in warp | 0.35 mm ≥ 6 | | 4.3 |
| | direction (kg) | 0.5 mm ≥ 12 | | |
| | | 0.7 mm ≥ 18 | | |
| 3 | Thickness (mm) | +0.1 | | 0.53 |
| 4 | Rubbing fastness (grade) | Dry rubbing | ≥4 | 4 |
| | | fastness | | |
| 5 | | Wet rubbing | ≥3-4 | 4 |
| | | fastness | | |
| 6 | Yellowing resistance | UV lamp for 3 h | ≥4 | 4 |
| 7 | (grade) | Sunlight lamp | | 4 |
| | | for 24 h | | |
| 8 | TAber wear-resistant | 300 times | No | None |
| | | | damage | |
| 9 | Low temperature bending | −20° C. | No | None |
| | test | 30,000 times | damage | |
| 10 | Normal temperature | 100,000 | No | None |
| | bending test | times | damage | |
| 11 | Hot air aging test (grade) | 70° C., 72 h | ≥4 | 4 |
| 12 | Wet heat aging test | 70° C., | ≥4 | 4 |
| | (grade) | 95% RH | | |
| | | 72 h | | |

| 13 | Solvent resistance | Soaking for 3 minutes, | None |
|---|---|---|---|
| | | taking it out and | |
| | | standing for 1 minute, | |
| | | then scraping it back | |
| | | and forth 10 times with | |
| | | tweezers. | |
| 14 | Hydrolysis resistance | 24 h | None |
| 15 | Peel strength (N/cm) | ≥24 | 26 |

When sole laying is required, only the first substrate layer 5 needs to be separated, and the adhesive layer 4 is directly adhered to the sole, that is, the adhesive layer 4 is contacted with the sole to achieve the adhesive effect, so that the sole laying for products can be conducted directly, which will make the sole adhesion better and save working hours.

The above description is only a preferred embodiment of the present invention, and is not intended to limit the present invention. It should be noted that, for a person of ordinary skill in the art, several improvements and variations may be made without departing from the technical principles of the present invention, and these improvements and variations should also be regarded as the scope of protection of the present invention.

What is claimed is:

1. A composite film with clear texture and high quality comprising a texture layer (1), a protective coating layer (2), a printed coating layer (3), an adhesive layer (4) and a first substrate layer (5) sequentially laminated from a top layer to a bottom layer, wherein the protective coating layer (2) is provided on a surface of the texture layer (1) facing the first substrate layer (5), the printed coating layer (3) is provided on a surface of the protective coating layer (2) facing the first substrate layer (5), and the texture layer (1) is connected to the first substrate layer (5).

2. The composite film with clear texture and high quality according to claim 1, wherein a surface of the first substrate layer (5) away from the texture layer (1) is further provided with an anti-deformation support structure layer, the anti-deformation support layer comprises a hot melt adhesive layer (6) and a second substrate layer (7), the hot melt adhesive layer (6) is provided on a surface of the first substrate layer (5) away from the texture layer (1), and the second substrate layer (7) is connected to the first substrate layer (5) by the hot melt adhesive layer (6).

3. The composite film with clear texture and high quality according to claim 1, wherein the texture layer (1) is made of polypropylene texture papers, and the texture layer (1) is provided with different textures in different areas and a plurality of colors are used in an alignment printing.

4. The composite film with clear texture and high quality according to claim 1, wherein a thickness of the texture layer (1) is ≥0.1 mm.

5. The composite film with clear texture and high quality according to claim 2, wherein the protective coating layer (2) is specifically a varnish layer.

6. The composite film with clear texture and high quality according to claim 1, wherein the second substrate layer (7) is made of polypropylene texture papers.

7. The composite film with clear texture and high quality according to claim 4, wherein the thickness of the second substrate layer (7) is ≥0.3 mm.

8. The composite film with clear texture and high quality according to claim 1, wherein the first substrate layer (5) is made of a thermoplastic polyurethane elastomer material.

9. A preparation process of a composite film with clear texture and high quality for preparing the composite film with clear texture and high quality according to claim 1, comprising:
S1, preparing a texture layer (1): setting different textures in different areas of the texture layer (1) according to specific requirements, printing different colors in different areas of the texture layer (1) by an alignment printing to obtain the texture layer (1);
S2, preparing a protective coating layer (2): adopting a corona process for coating and controlling a coating temperature at 90° C. and a thickness at 0.06 mm, coating a varnish material on a surface of the texture layer (1) to form a protective coating layer (2), and transferring textures on the texture layer (1) to the protective coating layer (2);
S3, preparing a printed coating layer (3): adopting an inner printing method and controlling the temperature at 40° C. to 60° C., forming a printing ink on one side with a protective layer on the texture layer (1), forming a printing coating (3), and obtaining a printing coating (3);
S4, preparing an adhesive layer (4): coating an adhesive to form the adhesive layer (4) on one side of the texture layer (1) on which a functional composite layer is formed; and
S5, preparing a composite film: the texture layer (1) is joined and bonded to the first substrate layer (5) through the adhesive layer (4), the first substrate layer (5) has a temperature of 180° C. and a tension of 0.18 N, the curing temperature is controlled to 60° C., and curing time is set to 48 hours for baking to form the composite film.

10. The preparation process of the composite film with clear texture and high quality according to claim 9, further comprising: uniformly coating a hot melt adhesive on a surface of an other side of the first substrate layer (5) to form the hot melt adhesive layer (6), and connecting the first substrate layer (5) and the second substrate layer (7) through the hot melt adhesive layer (6).
